(19) United States
(12) Patent Application Publication
(10) Pub. No.: US 2018/0237322 A1
(43) Pub. Date: Aug. 23, 2018

(54) Apparatus to convert organic waste into syngas while manufacturing glass products and method thereof

(71) Applicant: Glass Incorporated, Chino, CA (US)

(72) Inventor: Albert Lewis, Chino, CA (US)

(73) Assignee: Glass Incorporated, Chino, CA (US)

(21) Appl. No.: 15/858,990

(22) Filed: Dec. 29, 2017

Related U.S. Application Data
(60) Provisional application No. 62/579,051, filed on Oct. 30, 2017.
(60) Provisional application No. 62/490,455, filed on Apr. 26, 2017.
(60) Provisional application No. 62/462,551, filed on Feb. 23, 2017.

(51) Int. Cl. C03B 5/00; C03B 5/235; C03B 5/027; C03B 7/02; C03B 5/26; C01B 3/02; C03C 3/064; C03C 3/091; C10J 3/84

(52) U.S. Cl. CPC C03B 5/005; C03B 5/2356; C03B 5/0275; C03B 7/02; C03B 5/26; C10J 2300/0946; C03C 3/064; C03C 3/091; C10J 3/84; C03B 2211/22; C10J 2300/16; C01B 3/02

(57) ABSTRACT

This invention relates to using a production glass furnace to melt waste glass and other glass constituents thereby providing a radiant heat source within the furnace to efficiently gasify organic waste materials recovered from a variety of waste streams to thereby produce a synthesis gas (“Syngas”) that is comprised mostly of carbon monoxide, hydrogen, and carbon dioxide that can be further refined and sold as a high value fuel. The gasification of the organic waste within the production glass furnace has minimal impact on the composition of the glass melt thus allowing for the production of the same range of glass products as if no organic waste was added to the furnace.

Apparatus to convert organic waste into syngas while manufacturing glass products and method thereof.

### CROSS-REFERENCE TO RELATED APPLICATIONS

This application claims priority from the following U.S. provisional patent applications: Ser. No. 62/462,551 filed on Feb. 23, 2017; Ser. No. 62/490,455 filed on April 26, 2017; and Ser. No. 62/579,051 filed on Oct. 30, 2017. The disclosures of the prior applications are considered to be part of the disclosure of the accompanying application and are hereby incorporated by reference.

### BACKGROUND OF THE INVENTION

### 1. Field of the Invention

This invention relates to a novel glass furnace and associated process that disassociate through gasification the chemical constituents in organic waste that is charged into the glass furnace into syngas by using the radiant heat of the melted glass within the furnace with little to no contamination of the glass melt that may then be used to produce any number of glass products such as fiber glass, glass beads, and ceramic-glass beads.

### 2. Description of the Related Art

Many industrial processes require the use of high temperature furnaces. For instance, certain products sourced from glass or steel, are produced by heating the source material to temperatures sufficiently high enough to melt the material which is then transported in its liquid state to production equipment and processes which then create a commercially useful product from the melt. Traditionally, the heating step has been carried out by introducing the source material into a specially designed furnace and directly heating the source material in the furnace by combusting a fuel, using electricity, or both but not at the same time. The process of heating the material consumes a tremendous amount of energy and there have been many proposed means of capturing the heat to reuse it for another purpose. One proposed purpose is for gasification of organic waste into its chemical constituents.

The effective management and utilization of waste is a global issue. Current waste management techniques, as suggested by regulatory agencies, such as the U.S. Environmental Protection Agency (EPA), include source reduction first, recycling and composting second, and, finally, disposal in landfills or waste combustors. Other techniques of managing waste include converting the waste to energy involving processes such as incineration and pyrolysis. There are many types of waste including municipal solid waste, commercial and industrial waste, construction and demolition waste, electronic waste, medical waste, nuclear waste, and hazardous waste. Municipal solid waste (MSW), also called urban solid waste, trash, rubbish, or garbage, mainly comprises household/domestic waste. MSW is generally in solid/semi-solid form and includes both organic and inorganic materials such as paper, cardboard, plastic, textiles, glass, metals, biodegradable waste (e.g., food waste, yard sweepings/trimmings, wood waste), inert waste (e.g., dirt, rocks) and may include small quantities of miscellaneous materials such as batteries, light bulbs, medicines, chemicals, fertilizers, among other materials. Typically, MSW is found to be predominantly paper, cardboard, wood, yard waste, and food waste, although exact compositions can vary from one region to another (e.g., depending upon the levels of recycling carried out in that region). Without the effective management of waste, available landfill space within the United States will diminish. Other problems associated with landfills include the production of greenhouse gases, groundwater pollution, adverse impact on local biodiversity, and more.

A form of waste management includes gasification. Gasification is a process for the conversion of a carbonaceous feedstock such as coal, petroleum, biofuel, biomass, organic waste, and other wastes by exposure to high temperature and the addition of oxygen into a combustible gas such as synthesis gas. Synthesis gas, commonly referred to as syngas, is a mixture of varying amounts of carbon dioxide, carbon monoxide and hydrogen (CO2+CO+H2) and has a variety of applications. The syngas can be used to generate power by combusting it directly in a gas turbine, boiler or reciprocating engine, by feeding it into a fuel cell, and/or waste heat can be used in the generation of steam which can provide additional power through a steam turbine. Syngas can also be used for the production of hydrogen or liquid fuels or chemicals, gaseous fuels, synthetic natural gas, and/or carbon monoxide, some of which may be used as raw materials in the manufacture of other chemicals such as plastics. Gasification is thus a process for producing value-added products and/or energy from carbonaceous materials.

The high temperatures required to operate many furnaces are ideal for the gasification of organic wastes. It would be very desirable to operate a glass furnace to produce any number of glass products while at the same time taking advantage of the high temperatures within the furnace to gasify organic waste and produce syngas. There are a number of benefits such as making more effective use of an industrial furnace, leveraging the heat required to melt the glass to also gasify the organic waste, reducing the amount of waste that would otherwise be deposited into a landfill, and of course the creation of syngas which may be sold or combusted on site or used for other processes. It has been the object of individuals to create a furnace that would not only melt glass but also gasify organic waste.

An example of one such proposed means is U.S. Pat. No. 9,163,187 issued to Galley et al. on Oct. 20, 2015 titled “Gasification of combustible organic materials”. Here Galley discloses a first furnace melting glass that is part of a larger system that also comprises a boiler and a second furnace and a process for converting combustible organic waste materials into “synthesis gas” more commonly known as “syngas”. In Galley's disclosure the organic waste material is mixed with the glass melt of the first glass furnace and via pyrolysis of the organic waste material along with the introduction of steam or air syngas is produced. The syngas is then transported to the second furnace and is used to assist other combustion processes already present in the second furnace to melt the contents therein so as to create commercial products. The heat created by the second furnace is then transported to a boiler where steam is created via a heat exchange process. The steam created by the boiler is then transported to the first glass furnace and the process repeats. The glass in the first furnace, having been contaminated by the organic waste material that remains, contains undesirable oxides and heavy metals that are rendered inert (neutralized) in a glassy mass. This glassy mass is discharged from the first furnace and granulated for disposal or used as granules in civil engineering applications. Examples include use as a filler for bitumen or asphalt type materials for roads, pavements or other construction materials. While the Galley disclosure reduces the amount of waste that would normally be assigned to a landfill by converting much of it into syngas or as a filler material it is a rather complex industrial system where the first glass furnace, boiler, and second furnace along with any interconnecting schemes must be built in close proximity. The cost of implementing such a system and the associated land requirements makes the Galley disclosure difficult to implement. In addition, the glass melt in the first glass furnace is contaminated by the organic waste and is thus limited as to the range of possible glass products that may be manufactured from it.

US patent application publication 2017/0336070 by Inskip discloses a furnace and method thereby wherein waste heat from the furnace is used to promote a depolymerization process in waste plastics that creates a combustible fuel. A loop is thereby created, in which waste heat from the furnace drives the thermal depolymerisation process, and fuel produced by thermal depolymerisation is fed back into and consumed by the furnace. An advantage with the Inskip disclosure is that the melt within the furnace is never in contact with the waste plastic and thus is not contaminated by the waste plastic and is suitable for all of its intended commercial uses. However the depolymerization process as to plastics is a relatively low temperature process and not conducive to high temperature processes wherein glass products are made.

Known systems do not provide for a glass furnace that simultaneously melts a glass charge while also gasifying organic waste into syngas without contaminating the glass melt and thereby limiting the range of possible glass products that may be manufactured.

### BRIEF SUMMARY OF THE INVENTION

It is an object of the invention to provide for a glass furnace and process that allows for the gasification of waste organic material into syngas and for the melting of glass for use in a variety of commercial uses simultaneously within the furnace.

It is another object of the invention to refine the syngas within the associated channel of the furnace to remove the tar and other contaminants thus improving the purity of the syngas for its intended purpose.

The body of the furnace will generally be cylindrical in geometry with a vertical orientation and may be divided into two portions: a lower and an upper portion. The lower portion will be occupied by melted glass batch materials that may be used in the production of any number of glass products. The upper portion is a void space.

In the lower portion of the body an arrangement of burners using an air/gas mixture as fuel may be found followed by an arrangement of electrodes. The burners and electrodes are for the heating of the glass batch material within the lower portion of the body. Also within the lower portion of the body is a glass batch material pressure feeder, an opening to remove slag, and a bubbler ring to inject one or more of oxygen, air, or steam into the glass melt.

In the upper portion there are two ports, a first port for the introduction of glass batch material to augment the glass batch material pressure feeder found in the lower portion of the body and a second port for the introduction of organic waste into the body. The second port is found at the apex of the furnace body. Finally, an upper bubbler ring for the injection of one or more of oxygen, air, or steam into the upper portion of the body may be found.

At the division of the lower and upper portions will be found a port to draw off the melted glass batch material. The port leads into a channel that transports the melted glass batch material to the forehearth where the melted glass batch material is then presented to glass production equipment to manufacture glass fiber insulation, glass beads, and ceramic-glass beads. The channel is further divided into multiple zones with each zone containing independently controlled electrodes to maintain the temperature of the melted glass batch material at a proper level within that zone. The channel also allows for the passage and refinement of the syngas produced when the organic waste is gasified.

The method of producing the syngas begins with charging the lower portion of the body with glass batch material to a proper level. Once the body has been so charged the burners will be activated to begin the heating process and will continue to heat the glass batch material until the glass batch material is sufficiently melted to a viscosity of log four to log five to allow for the proper operation of the electrodes. At this point the burners are deactivated and the electrodes are activated. It is important that the burners are not active when the organic waste is gasifying as the gases created by the burners disrupt the ambient air flow in the upper portion of the furnace body. It is essential that there are no disruptions to the ambient air flow in the upper portion of the furnace body when the organic waste is introduced above the surface of the melted glass batch material. Once the electrodes have heated the glass batch material to the required temperature the organic waste may be charged into the upper portion. As the organic waste falls into the furnace body it will be exposed to increasingly greater temperatures. One or more of oxygen, air, or steam supplied by the lower and upper bubbler rings will react with the organic waste at a set temperature, and the organic waste will gasify into syngas. The syngas is drawn into the channel where it passes above the melted glass batch material flowing in the channel. As the syngas travels between the zones in the channel, tar and other impurities are removed by the continued exposure to the high temperatures of the melted glass batch material traveling below the syngas. At the end of the channel the syngas is drawn off to be processed into other gases. The melted glass batch material is fed into glass manufacturing equipment to manufacture either glass fiber insulation, glass beads, or ceramic-glass beads. Any organic waste that is not gasified drops into the melted glass batch material and reacts with the oxygen or steam being injected by the lower bubbler ring for a second attempt to gasify the organic waste into syngas. Failing the second attempt, the residual material from the organic waste, which may be ash, precipitates to the bottom of the furnace body having been rendered inert (neutralized) in a glassy mass to be removed as slag, granulated for use in civil engineering applications as a filler for bitumen or asphalt type materials for roads, pavements, or for other potential uses.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

Neither this summary nor the following detailed description defines or limits the invention. The invention is defined by the claims.

### BRIEF DESCRIPTION OF DRAWINGS

The present invention will become more fully understood from the detailed description and accompanying drawings, wherein:

FIG. 1 is a cross sectional view of the preferred embodiment of the furnace according to the present invention.

FIG. 2 is a cross sectional view of a secondary embodiment of the furnace according to the present invention.

FIG. 3 is an isometric view of the body of the furnace with many components removed to show detail of the bubbler rings.

FIG. 4 is a flowchart depicting the process of preparing and melting glass batch material to a liquid state for use in the manufacture of commercial glass products while simultaneously using the waste heat from such process to gasify organic waste to produce syngas from the same glass furnace.

FIG. 5 is a flowchart depicting the process of heating the glass batch material to a liquid state in the furnace.

### DETAILED DESCRIPTION OF THE INVENTION

The following description of the preferred embodiment(s) is merely exemplary in nature and is in no way intended to limit the invention, its application, or uses.

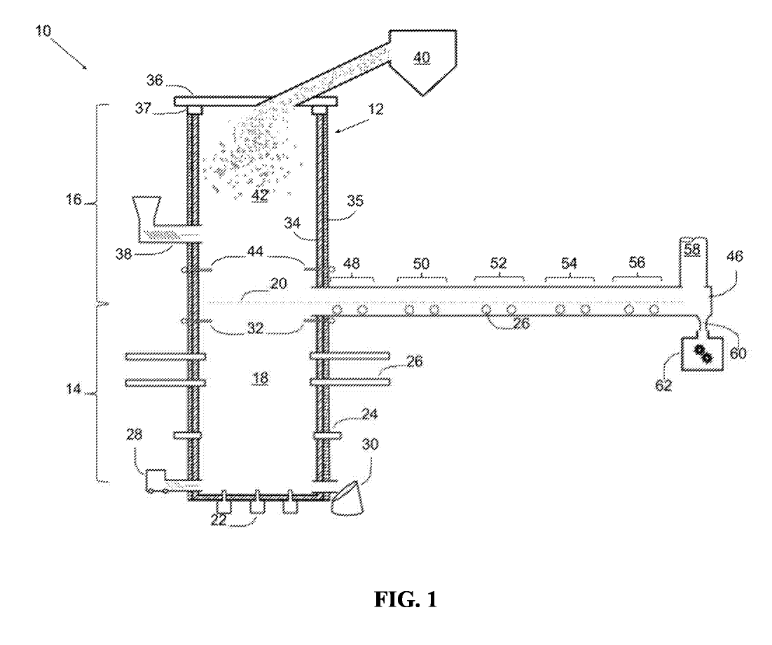

FIG. 1 shows a cross sectional view of the preferred embodiment of furnace 10 of the present invention. Furnace 10 is basically comprised of two major components, body 12 and channel 46. Body 12 may further be divided into two portions, lower portion 14 and upper portion 16. In the preferred embodiment body 12 is cylindrical and is vertical along its axis but other geometric configurations are possible such as rectangular, elliptical, and other multisided shapes as long as body 12 may be characterized into lower portion 14 and upper portion 16. Lower portion 14 is filled with glass batch material 18 which may consist of waste glass originating from municipal solid waste that contains a variety of glass wastes such as bottles, dinnerware, window glass, and the like; standard glass batch material known in the art of glass making; or from a combination of both waste glass and glass batch material. For the purpose of this disclosure the term “glass batch material” may refer to waste glass, glass batch material, or a combination of both. The surface level of melted glass batch material 18 defines the boundary between lower portion 14 and upper portion 16 and is referred to as glass surface line 20. Although lower portion 14 and upper portion 16 are shown in FIG. 1 as occupying a similar percentage of body 12 this is not a limitation.

At the base of body 12 are shown three submerged burners 22 combusting natural gas with one or more of hydrogen, oxygen, or air. Submerged burners enhance heat transfer by mixing the fuels and oxidant produced by submerged burners 22 directly into and under the surface of glass batch material 18 being melted. Placing submerged burners 22 in the base of body 12 results in improved heat transfer and vigorous convective stirring of the melt. The three submerged burners 22 are shown as an example and the actual count may vary depending upon the size of body 12.

Depending upon the size of body 12 side burners 24 may be employed to assist submerged burners 22 in melting glass batch material 18 within lower portion 14. Similar to submerged burners 22, side burners 24 also combust natural gas with one or more of hydrogen, oxygen, or air and the actual count varies depending upon the size of body 12. However once glass batch material 18 melts and achieves a certain viscosity, submerged burners 22 and side burners 24 are to be turned off and electrodes 26 are to be turned on.

Glass batch material 18 conducts electricity once it has melted and electrodes 26 may heat glass batch material directly by passing an electrical current through the molten glass batch material 18. Electrodes 26 are commonly made from molybdenum as molybdenum is less affected by oxidation at the high temperatures found in glass melting furnaces and provides a reasonably long and reliable life. Electrode lifespan may be further increased by coating the electrodes with a zirconium based oxide. It is important to turn off submerged burners 22 and side burners 24 because of their vigorous convective stirring of melted glass batch material 18 is disruptive to the ambient air in upper portion 16, and their use adversely impacts the reliability and life of electrodes 26. It is important, for the purposes of this disclosure, that the ambient air in upper portion 16 is left undisturbed to the extent possible.

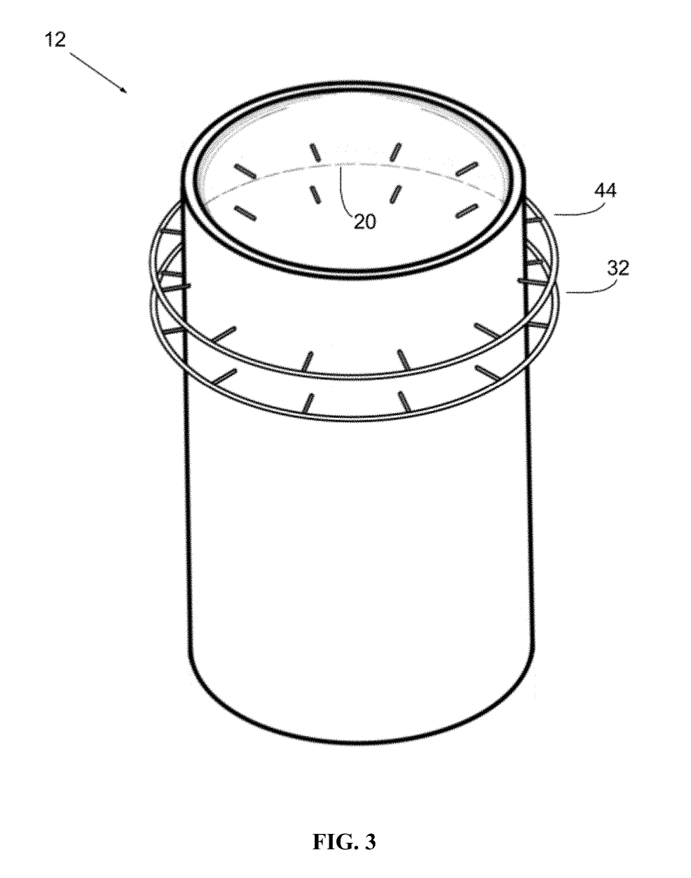

About the perimeter of body 12 and below glass surface line 20 is lower bubbler ring 32. Lower bubbler ring 32 is a tube encircling the perimeter of body 12 with one or more nozzles projecting through body 12 and into glass batch material 18. By feeding one or more of hydrogen, oxygen, air, or steam into the tube the same may be fed into melted glass batch material 18. Introducing one or more of hydrogen, oxygen, air, or steam into the organic waste is part of the gasification process of the organic waste. FIG. 3 shows body 12 with lower bubbler ring 32 and upper bubbler ring 44 about glass surface line 20 with roof 36 removed to show the nozzles projecting within body 12. Nozzles may be all of the same length or the lengths between nozzles may vary.

At the base of body 12 is lower glass batch material feeder 28 that is used to feed glass batch material 18 into body 12 to replace glass batch material 18 that is withdrawn along channel 46 and passed out through glass melt feeder 60 and into glass production equipment 62. Also at the base of body 12 is slag receiver 30 that is used to draw off organic waste that has not gasified. Slag recovered from body 12 may be diverted to a storage and processing area where it may be granulated to be used as highway roadbed material or other uses, or its chemistry may be modified to provide a new glass that can be processed into other glass and/or glass ceramic materials. These may include high temperature fibers or high strength fracking beads or alkali free concrete components and structures, and the such. Finally, to prolong the operational life of body 12, refractory material 34 provides a layer of thermal protection to the inside walls of body 12 while water jacket 35 positioned outside and about body 12 operates to cool body 12. Examples of possible refractory materials include mullite brick, zircon brick, alumina bubble brick, sillimanite brick, corundum brick, fireclay brick, high alumina brick, and others.

Upper portion 16 is bounded by glass surface line 20 and roof 36. Any gap between roof 36 and body 12 is sealed by roof seal 37. It is important that upper portion 16 is isolated from the air and air movement outside of body 12. Once glass batch material 18 has melted and has reached a certain temperature the gasification process may begin by feeding organic waste 42 from waste feeder 40 into upper portion 16. Organic waste 42 must be dropped from above glass surface line 20 into an ambient air space that is free from disruptive air movements so that organic waste may freely fall through upper portion 16. As organic waste 42 is falling, upper bubbler ring 44, consisting of a tube that may be supplied with one or more of hydrogen, oxygen, air, or steam along with one or more nozzles that project into body 12, may inject one or more of hydrogen, oxygen, air, or steam into the falling mass of organic waste 42 as part of the gasification process. FIG. 3 shows body 12 with lower bubbler ring 32 and upper bubbler ring 44 above glass surface line 20 with roof 36 and roof seal 37 removed to show the nozzles projecting within body 12. Nozzles may be all of the same length or the lengths between nozzles may vary. Upper glass batch material feeder 38 may be used to replenish glass batch material 18 that has been withdrawn along channel 46 and passed out through glass melt feeder 60 and into glass production equipment 62.

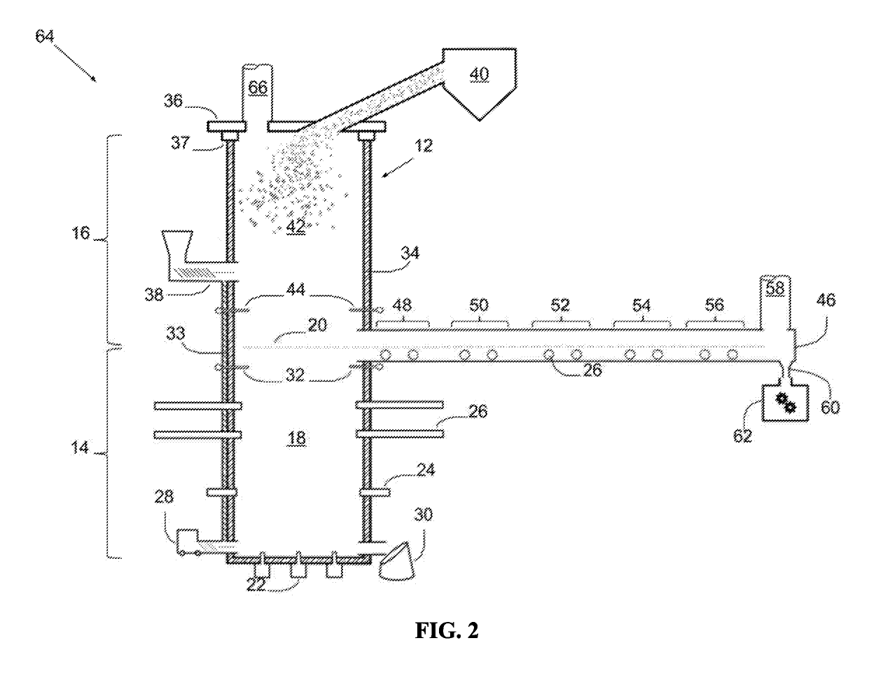

About glass surface line 20 is channel 46 to lead melted glass batch material 18 away from body 12 and towards glass melt feeder 60 where glass batch material 18 is then presented to glass production equipment 62. Channel 46 is also used to draw syngas produced by the gasification process occurring in upper portion 16 to travel above glass batch material 18 and into forehearth syngas vent 58. Channel 46 is divided into one or more zones wherein each zone contains one or more electrodes 26 that are controlled independently of electrodes in the remaining zones. As shown in FIGS. 1 and 2, channel 46 contains five zones: 48, 50, 52, 54, and 56. Glass batch material 18, being in close contact with the syngas, may further operate on the syngas passing above it working to remove tar and other contaminants by further exposing the syngas to the high temperatures of glass batch material 18. Electrodes 26 within each zone may raise and lower the temperature of the glass batch material passing through that zone.

FIG. 2 shows a second embodiment of the furnace of the invention. Here furnace 64 is shown which is identical to furnace 10 with the exception of roof vent 66 and chute 33. Roof vent 66 is used to vent syngas within upper portion 16 that is not drawn into channel 46. Syngas drawn by roof vent 66 does not receive the benefit of the syngas refinement process within channel 46 thus will have higher amounts of tar and other contaminants. Chute 33 allows glass batch material 18 to flow from upper glass batch material feeder 38 to lower glass batch material feeder 28 where glass batch material 18 is then pressure fed into lower portion 14.

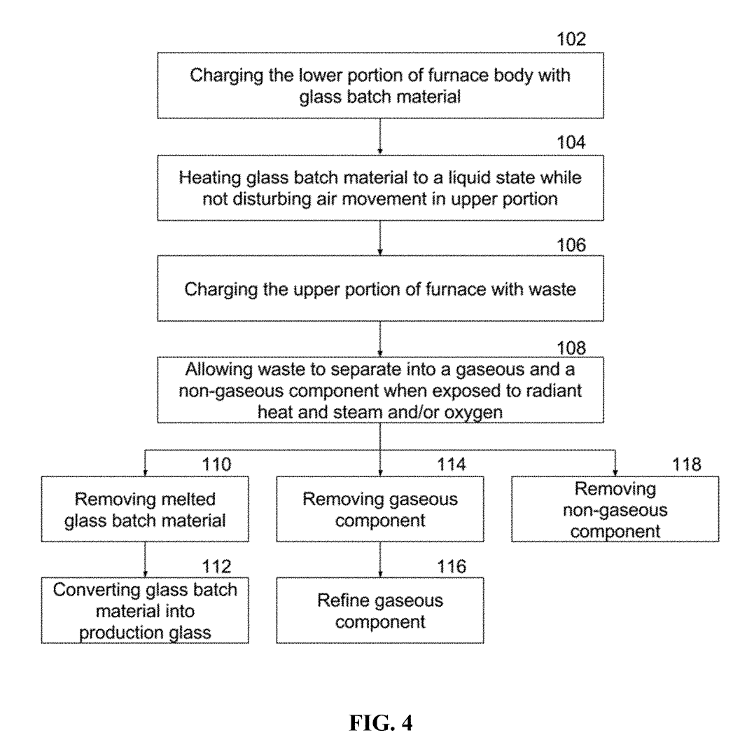

FIG. 4 shows a flowchart of the preferred method of the present invention. Step 102 is to charge lower portion 14 of body 12 with glass batch material 18 to glass surface line 20. This is to be accomplished by introducing glass batch material from upper glass batch material feeder 28, but lower glass batch material feeder 28 may also be used if pre-existing glass batch material 18 is granular or the melted glass has a viscosity of log four to log five. Once body 12 has been charged to glass surface line 20 with glass batch material 18 step 104 will activate heaters within body 12 to melt glass batch material 18 to an appropriate temperature and viscosity and maintain that temperature and viscosity without creating any disturbance of the ambient air within upper portion 16. It is important that the ambient air within upper portion 16 is undisturbed and that the heat radiating from glass batch material 18 is allowed to radiate uniformly and cool during its upward movement within upper portion 16. Once the ambient conditions within upper portion 16 are properly set and there is no air movement other than the air movement caused by the heat radiating from melted glass batch material 18, step 106 will be to charge upper portion 16 with organic waste 42 using organic waste feeder 40. Step 108 depicts organic waste 42 as it falls through upper portion 16. Heat radiating from melted glass batch material 18 along with one or more of hydrogen, oxygen, air,or steam from upper bubbler ring 44 will cause organic waste 42 to separate into a gaseous component and a non-gaseous component with the gaseous component comprised primarily of carbon monoxide, hydrogen and carbon dioxide but with small additional quantities of methane, nitrogen, argon and other trace constituents and the non-gaseous component comprised primarily of ash. Steps 110, 114, and 118 occur simultaneously. In step 110 the melted glass batch material 18 is removed from body 12 through channel 46. As melted glass batch material 18 leaves body 12 into channel 46 additional glass batch material 18 will be added to lower portion 14 to maintain the amount of melted glass batch material 18 at glass surface line 20. Step 112 depicts the transfer of melted glass batch material 18 from channel 46 to glass production equipment 62 to convert the melted glass batch material 18 from a melted form into a form with market value such as glass fibers, reflective beads, cleaning and polishing glass beads, glass beads for atomizing and mixing in spray cans, or other products such as fritted glass to be used as strengthening agents in plastic and cement. Step 114 depicts the removal of the gaseous component by forehearth vent 58 in furnace 10 or by both forehearth vent 58 and roof vent 66 in furnace 64. If the gaseous component is removed via forehearth vent 58 it must travel through channel 46 and while doing so tars and other impurities that exist in the gaseous component may be removed by continued exposure to heat radiating from melted glass batch material 18 that also flows in channel 46 as depicted in step 116. Channel 46 may be divided into one or more zones with each zone having one or more independently controlled electrodes 26 and the temperature of the melted glass batch material 18 flowing in a zone may be altered by the presence of electrodes 26. At the proper temperature tar and other impurities will be consumed by the heat radiating from melted glass batch material 18 or will precipitate into melted glass batch material 18. The amount of tar or other impurities that may precipitate into melted glass batch material 18 is inconsequential. Step 118 involves the removal of the non-gaseous component which is typically ash but will contain other impurities and will be referred to as slag. The ash precipitates into melted glass batch material 18 to the bottom of body 12 where it may then be removed by slag receiver 30 for disposal, to produce ceramic glass beads for fracturing of products for the petroleum industry or it may be ground down to be used as highway roadbed material or for other uses.

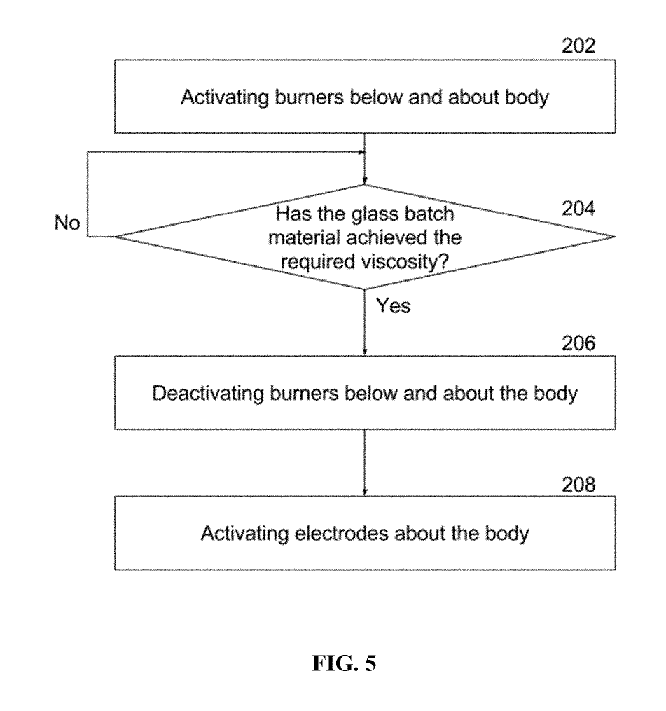

FIG. 5 provides additional details into the process of melting the glass batch material 18 to a proper temperature and viscosity. The process starts with step 202 where submerged burners 22 and side burners 24 are activated to start the melting process. Glass batch material 18 does not conduct electricity while being in a solid state so electrodes may not be used. Submerged burners 22 and side burners 24 are powered by combustible gasses such as a mixture of natural gas and either air or oxygen. As submerged burners 22 and side burners 24 heat glass batch material 18 eventually glass batch material 18 will achieve a state where electricity may be conducted as shown in step 204. At this point submerged burners 22 and side burners 24 will be deactivated as shown in step 206. In step 208 electrodes 26 are activated for a number of reasons the primary being that the electrodes do not disturb melted glass batch material 18 to the extent that the burners do thus satisfying the requirement that the ambient air in upper portion 16 remain as calm as possible. The fact that electrodes are more efficient at heating melted glass batch material 18 and are more environmentally friendly than burners form secondary reasons for using electrodes over burners.

The composition of glass batch material 18 varies upon the nature of the glass that is to be produced by glass production equipment 62 which includes but is not limited to glass fibers, reflective beads, cleaning and polishing glass beads, glass beads for atomizing and mixing in spray cans, or other products such as fritted glass to be used as strengthening agents in plastic and cement. These compositions have been the subject of many patents including U.S. Pat. Nos. 6,998,361 and 7,189,671 both issued to Albert Lewis. Table 1 discloses typical compositional ranges of oxides for a variety of glass products.

TABLE 1

| Oxide | Low | High |
|---|---|---|
| SiO₂ | 35.0 | 84.0 |
| Fe₂O₃ | 1.0 | 12.0 |
| Al₂O₃ | 1.0 | 27.0 |
| MgO | 1.0 | 5.0 |
| B₂O₃ | 3.0 | 10.0 |
| Na₂O | 3.0 | 10.0 |
| C₂O | 2.0 | 15.0 |
| BaO | 2.0 | 10.0 |
| K₂O | 1.0 | 10.0 |
| BeO | 3.0 | 5.0 |

All patents and publications mentioned in this specification are indicative of the levels of those skilled in the art to which the invention pertains. All patents and publications are herein incorporated by reference to the same extent as if each individual publication was specifically and individually indicated to be incorporated by reference.

It is to be understood that while a certain form of the invention is illustrated, it is not to be limited to the specific form or arrangement herein described and shown. It will be apparent to those skilled in the art that various changes may be made without departing from the scope of the invention and the invention is not to be considered limited to what is shown and described in the specification and any drawings/figures included herein.

One skilled in the art will readily appreciate that the present invention is well adapted to carry out the objectives and obtain the ends and advantages mentioned, as well as those inherent therein. The embodiments, methods, procedures and techniques described herein are presently representative of the preferred embodiments, are intended to be exemplary and are not intended as limitations on the scope. Changes therein and other uses will occur to those skilled in the art which are encompassed within the spirit of the invention and are defined by the scope of the appended claims. Although the invention has been described in connection with specific preferred embodiments, it should be understood that the invention as claimed should not be unduly limited to such specific embodiments. Indeed, various modifications of the described modes for carrying out the invention which are obvious to those skilled in the art are intended to be within the scope of the following claims.

What is claimed is:

1. A furnace comprising:
a hollow body closed to outside air;
a means for charging the lower portion of said body with material;
a means of heating said material to a liquid state while not disturbing air movement in upper portion of said body;
a means for charging the upper portion of said body with waste that separates into gaseous and non-gaseous components when exposed to the heat radiating from heated said material;
a means of supplying one or more of steam, air, natural gas, hydrogen, or oxygen to said waste;
a means of removing said material;
a means of removing said gaseous components;
a means of removing said non-gaseous component; and
a means of presenting said material to production equipment and producing commercially valuable products.

2. The furnace of claim 1 wherein said means of supplying one or more of steam, air, natural gas, oxygen, or hydrogen to said waste comprises one or more lower bubbler rings positioned below the surface level of said material and about the outer periphery of said body containing one or more tubes that protrude into and injects gas into said body.

3. The furnace of claim 2 wherein said lower bubbler rings contains one to sixteen tubes.

4. The furnace of claim 1 wherein said means of supplying one or more of steam, air, natural gas, oxygen, or hydrogen to said waste comprises one or more upper bubbler rings positioned above the surface level of said material and about the outer periphery of said body containing one or more tubes that protrude into and injects gas into said body.

5. The furnace of claim 4 wherein said upper bubbler rings contains one to sixteen tubes.

6. The furnace of claim 1 wherein said body is of such geometric shape so that said body lower portion contains said material and said body's upper portion is a void charged with said waste.

7. The furnace of claim 6 wherein said body is a cylinder.

8. The furnace of claim 6 wherein said body is rectangular.

9. The furnace of claim 6 wherein said body is octagonal.

10. The furnace of claim 6 wherein said body is square.

11. The furnace of claim 6 wherein said body is a sphere.

12. The furnace of claim 1 wherein said material is glass batch material.

13. The furnace of claim 1 wherein said means for charging lower portion of said body is a batch feeder positioned above the surface level of said material.

14. The furnace of claim 1 wherein said means for charging lower portion of said body is a batch pressure feeder positioned below the surface level of said material.

15. The furnace of claim 1 wherein said heating means comprises burners combusting natural gas with one or more of air, oxygen, or hydrogen positioned below said body.

16. The furnace of claim 1 wherein said heating means comprises side burners combusting natural gas with one or more of air, oxygen, or hydrogen positioned about the periphery of said body below the surface level of said material.

17. The furnace of claim 1 wherein said heating means comprises electrodes positioned along the sides of said body below the surface level of said material.

18. The furnace of claim 17 wherein said electrodes are constructed from molybdenum coated with zirconium-based oxide.

19. The furnace of claim 1 wherein said heating means comprises electrodes installed in a staggered arrangement around the periphery of said body.

20. The furnace of claim 1 wherein said waste is organic matter such as wood, paper, cardboard, yard waste, tree trimmings, food waste, animal waste, human waste, agricultural waste, forest slash, and other organic content of municipal solid waste.

21. The furnace of claim 1 wherein said means for charging upper portion of said body is a waste feeder.

22. The furnace of claim 1 wherein said means of removing said material comprises a channel to transport said material to a forehearth.

23. The furnace of claim 22 further comprising equipment to process said material into commercially valuable products.

24. The furnace of claim 1 wherein said means of removing said gaseous component comprises a vent positioned above the surface level of said material.

25. The furnace of claim 24 wherein said vent further comprises equipment to process said gaseous component into commercially valuable products.

26. The furnace of claim 1 wherein said means of removing said material and said gaseous component comprises a channel and forehearth wherein said gaseous component travels above said material.

27. The furnace of claim 26 wherein said channel is further divided into zones with each zone having its own heating means.

28. The furnace of claim 27 wherein said heating means for said channel consists of electrodes.

29. The furnace of claim 27 wherein the temperature of said zones are independently controlled.

30. The furnace of claim 26 further comprising equipment to process said material into commercially valuable products.

31. The furnace of claim 29 further comprising equipment to process said gaseous component into commercially valuable products.

32. A hollow body furnace closed to outside air consisting of a lower portion containing glass batch material and a upper portion being void the body comprising:
one or more lower bubbler rings positioned about the outer periphery of said lower portion containing one or more tubes that protrude into and injects one or more of steam, air, natural gas, hydrogen, or oxygen into said body;
one or more upper bubbler rings positioned about the outer periphery of said upper portion containing one or more tubes that protrude into and injects one or more of steam, air, natural gas, hydrogen, or oxygen into said body;
a batch feeder positioned in said upper portion to charge said lower portion with glass batch material;
a batch pressure feeder positioned in said lower portion to charge said lower portion with glass batch material;
one or more burners combusting natural gas with air or air and oxygen positioned below said body;
one or more side burners combusting natural gas with one or more of air, oxygen, or hydrogen positioned positioned about the periphery of said lower portion;
one or more electrodes positioned about the periphery of said lower portion;
a waste feeder positioned in said upper portion to charge said upper portion with organic waste that separates into gaseous and non-gaseous components when exposed to the heat radiating from heated said glass batch material;
one or more channels positioned about the boundary of said lower and upper portions and leading away from said body to remove said gaseous component and melted said glass batch material in the channels:
being divided into one or more independently electrode controlled temperature zones,
having one or more vents at the end furthest from said body for said gaseous component to be captured, and
having one or more production equipment at the end furthest from said body for said glass batch material to be captured and converted into commercially valuable products; and
a slag removal device to capture said non-gaseous component.

33. A method for creating syngas from waste using a furnace comprising:
charging the lower portion of said furnace with glass batch material;
heating said glass batch material to a liquid state while not disturbing air movement above said glass batch material;
charging the upper portion of said furnace with waste;
supplying one or more of steam, air, oxygen, or hydrogen to said waste;
allowing said waste to separate into a gaseous and a non-gaseous component when exposed to said glass batch material's radiant heat;
capturing a portion of said glass batch material;
capturing said gaseous component; and
capturing said non-gaseous component.

34. The method of claim 33 wherein the step of charging the lower portion of said furnace with said glass batch material is performed by a glass batch feeder above the surface level of said glass batch material.

35. The method of claim 33 wherein the step of charging the lower portion of said furnace with said glass batch material is performed by a glass batch pressure feeder below the surface level of said glass batch material.

36. The method of claim 33 wherein the step of heating the furnace further comprises the steps:
activating burners positioned about the periphery and underneath said furnace;
waiting until said glass batch material has changed to a liquid;
deactivating said burners; and
activating electrodes that are positioned about the periphery of the furnace.

37. The method of claim 36 wherein said electrodes are inserted into the furnace after deactivating said burners.

38. The method of claim 36 wherein said heating step is capable of heating the furnace to a temperature of at least 1000° F.

39. The method of claim 33 where in the step of supplying one or more of steam, air, oxygen, or hydrogen to said waste is performed by one or more bubbler rings.

40. The method of claim 33 wherein said charging the upper portion of said furnace is controlled by rotary valve at an adjustable rate.

41. The method of claim 33 wherein the step of capturing a portion of said glass batch material further comprises the steps of:
continuously feeding said glass batch material at a controlled rate into said furnace so that the surface of said glass batch material enters a channel and moves therethrough; and
presenting said glass batch material to glass production equipment at the end of said channel.

42. The method of claim 33 wherein the step of capturing said gaseous component comprises a vent at the top of said furnace.

43. The method of claim 33 wherein the step of capturing said gaseous component further comprises the steps of:
passing said gaseous component conjointly with glass batch material through a channel that is divided into zones;
heating a said zone to an appropriate temperature using electrodes; and
capturing said gaseous component by a vent at the far end of said channel.

44. The method of claim 33 wherein the step of capturing said non-gaseous component comprises a slag removal device.
